(19) United States
(12) Patent Application Publication
(10) Pub. No.: US 2008/0180445 A1
(43) Pub. Date: Jul. 31, 2008

(54) Output Management Systems And Methods

(76) Inventor: Mark Peskin, Austin, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/668,368

(22) Filed: Jan. 29, 2007

(51) Int. Cl. G06T 11/20

(52) U.S. Cl. 345/440

(57) ABSTRACT

Systems and methods of output management are disclosed. In an exemplary implementation, an output management method may include generating a bifurcated transformation graph including a plurality of format nodes connected by a plurality of transformation edges and at least one production edge. The method may also include simplifying the bifurcated transformation graph. The method may also include identifying at least one optimal route through the simplified bifurcated transformation graph for efficient document management in a computer system.

### BACKGROUND

Documents generated on computers are commonly output to a wide variety of different types of devices. For example, a word processing document may be printed to a printer, faxed using a network fax machine, etc. Although not required, these documents are often sent from a network computer to a server computer for output.

In any event, the document may need to be converted to a different format before the document can be output. For example, document processing software may be executed to convert a word processing document into postscript format for output at a printer. Although this is a fairly straightforward conversion, other more complex conversions may be needed. For example, a word processing document may need to be converted to a standard text format for addition of a fax cover sheet, and then the text file including the original word processing document and the fax cover sheet may need to be converted to some other format for output by a fax machine. Still other more complex conversions may also be implemented, and are referred to as a “chain” of transformations (e.g., converting between file formats) and productions (e.g., modifying content such as adding a fax cover sheet to a document).

Some of these transformations and productions may need to be applied in a predetermined sequence in order to produce a document for output in the desired format to which appropriate content modifications have been made. Other transformations and productions may be applied in any order. Currently, however, there is little available for determining an optimal sequence for applying the transformations and productions, resulting in lower productivity than what could otherwise be realized.

### BRIEF DESCRIPTION OF THE DRAWINGS

FIG. 1 is a high-level illustration of an exemplary networked computer system which may implement output management systems and methods.

FIG. 2 is an exemplary transformation graph.

FIGS. 2a-c show, respectively, exemplary transformation graphs for Examples 1-3, in accordance with embodiments of the present invention.

FIG. 3 is a flowchart illustrating exemplary operations which may be implemented for output management according to an embodiment of the present invention.

### DETAILED DESCRIPTION

Output management systems and methods are disclosed. In exemplary embodiments, the output management systems and methods may be implemented in software (or other program code) to construct a chain of transformations and productions, and applying a chaining algorithm to a transformation graph describing the relationships between the various transformations and productions available to the system to determine an efficient sequence for applying the transformations and productions to a document. Accordingly, the systems and methods described herein may be implemented to increase productivity.

It should also be noted that in addition to document transformation, the optimization algorithm described below may also be applied to any other general class of problems that can be represented using a directed graph with self-loops.

### Exemplary Systems

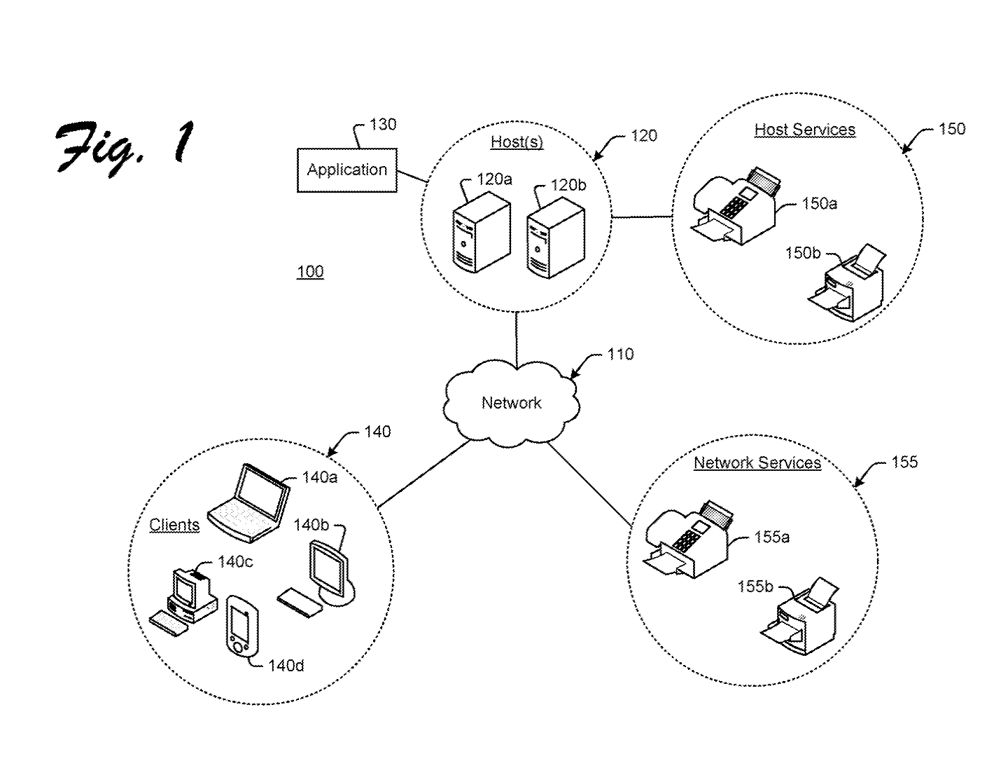

FIG. 1 is a high-level illustration of an exemplary networked computer system 100 which may implement output management systems and methods. The networked computer system 100 is shown as an exemplary environment in which the output management systems and methods may be implemented. Before continuing, however, it is noted that the output management systems and methods are not limited to use in computer networks, and may also be implemented in stand-alone devices.

For purposes of this illustration, the networked computer system 100 may include one or more communication networks 110, such as a local area network (LAN) and/or wide area network (WAN). Host(s) 120 (e.g., host computers 120a, 120b) may be implemented in the networked computer system 100 to handle transformations and productions for documents generated at one or more client computers 140 for output at one or more host services 150 (e.g., attached fax machine 150a or printer 150b) and/or for output at one or more network services 155 (e.g., network fax machine 155a or printer 155b).

Host 120 may include one or more computing systems, such as a server with computer-readable storage. Host 120 may include an output management application 130 stored on the computer-readable storage and implemented in software for executing the operations described in more detail below. Host 120 may also provide services to other computing or data processing systems or devices. For example, host 120 may also provide transaction processing services, email services, etc.

Host 120 may be provided on the network 110 via a communication connection, such as a dial-up, cable, or DSL connection via an Internet service provider (ISP). Host 120 may be accessed by one or more client 140 directly via the network 110.

The term “client” as used herein refers to a computing device which may be used to access the host 120 and services provided by the host 120 via the network 110. Client computing devices may include any of a wide variety of computing systems, such as a stand-alone personal desktop or laptop computer (PC), workstation, personal digital assistant (PDA), or appliance, to name only a few examples. Each of the client computing devices may include memory, storage, and a degree of data processing capability at least sufficient to manage a connection to the host 120. Client computing devices may connect to network 110 via a communication connection, such as a dial-up, cable, or DSL connection via an Internet service provider (ISP).

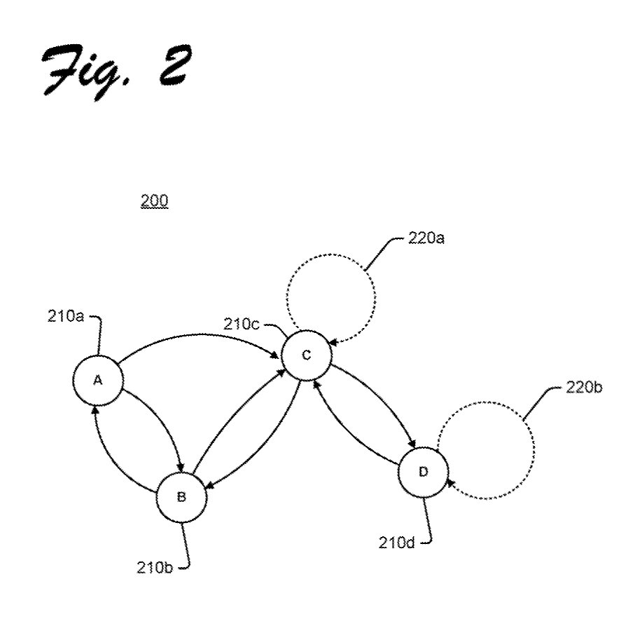

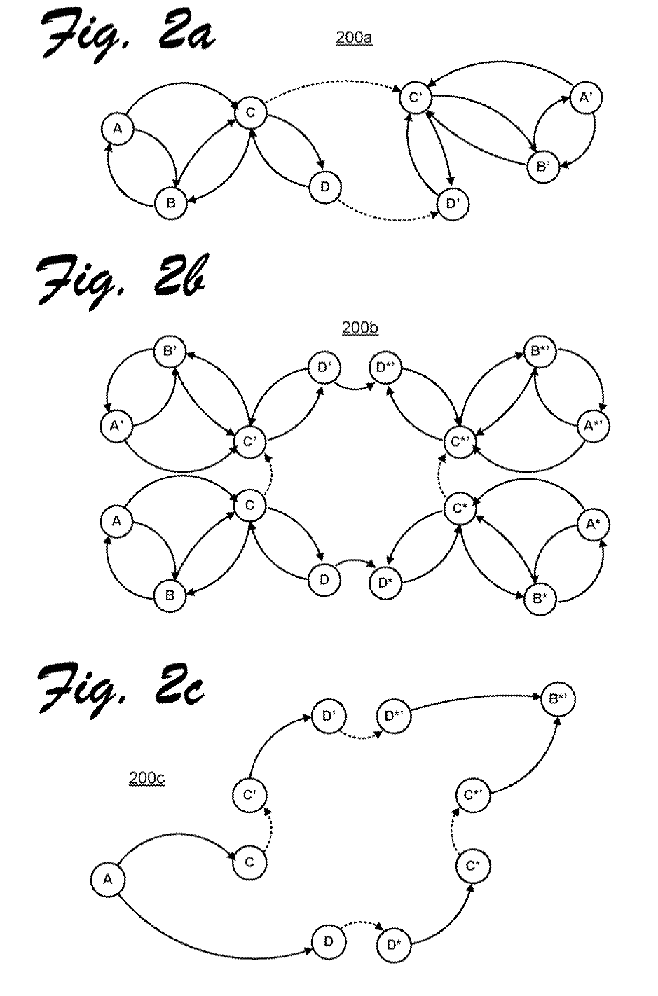

In an exemplary embodiment, a client 140 may generate a document for output by one or more of the host services 150 or network services 155. Output management application 130 processes the document by applying a chaining algorithm to a transformation graph describing the relationships between the various transformations and productions avialable to the system. The output management application 130 then determines an efficient sequence for applying the transformations and productions to the document. These operations are described by illustration in more detail below with reference to the transformation graphs shown in FIGS. 2 and 2a-b.

Before continuing, it may be useful to understand some terminology. The term “transformation graph” is used herein to describe a special form of directed network graph which describes a set of available transformations and productions. The term “node” or “nodes” (designated A-D, A′-D′, and A″-D″ in in Figures) represent the various document formats, and the term “edge” or “edges” (shown as arrows between the nodes) represent available transformations and productions. More specifically, transformations are represented by “directed edges” (i.e., connecting two different format nodes), and productions are represented by “self-loops” (i.e., connecting a node to itself).

FIG. 2 is an exemplary transformation graph 200 with four nodes 210a-d (i.e., formats A-D). There are several things to note about this representation. First, not all nodes 210a-d are directly connected to one another. For example there is no transformation directly from format A to format D. Documents of format A must first be transformed to format C before being transformed to format D. Second, not all transformations are reversible. For example, there is a transformation from A to C, but not from C to A. In order to go from format C to A, the document must first be transformed to format B. Productions can only be applied to specific formats. Thus, in this example, if the input format is A, and the desired output format is B, but the job intent specifies the production at format C, the document must still be transformed to format C at some stage in order for the production to be applied. In addition, a production type may exist at several format nodes. For example, it may be possible to apply line numbering directly to both a text document and a Postscript document. In other words, the productions at nodes C and D may actually be different instances of the same production type.

A transformation chaining algorithm determines an efficient or optimal (e.g., lowest cost and/or highest fidelity) route through the transformation graph, that is, from the node representing the document input format to the node representing the desired output format. A number of algorithms have been developed to efficiently calculate optimal routes through directed (and optionally, weighted) graphs. Of these, the Dijkstra algorithm is perhaps the most well-known, and is both relatively simple and efficient to apply. Other alternative algorithms include, but are not limited to, the Bellman-Ford and A* algorithms.

In the simplest case (i.e., there are no productions), the transformation graph 200 can simplified so that it does not include any self-loops. The Dijkstra algorithm can then be applied directly to the transformation graph to determine an optimal transformation chain.

However, when productions (e.g., production 220a at node C and production 220b at node D) are applied to a document, the situation can become considerably more complicated. Basic path optimization algorithms like Dijkstra do not select self-loops. Nor do these algorithms assure that a given node or set of nodes (e.g. nodes at which selected productions are available) is “touched” by the optimal path.

In the case where all requested productions exist at one and only one format node, this problem can be reduced to two applications of the Dijkstra algorithm. That is, first an optimal path is found from the initial format to the production format, and then an optimal path is found from the production format to the output format. However, this simplification is not applicable to the general case, where multiple productions may have to be applied at different format nodes, or where a single production type may be available at multiple nodes.

Because algorithms like Dijkstra cannot be applied directly in the general case, the transformation chaining algorithm instead uses a projection of the transformation graph to which Dijkstra (or other optimization algorithms) can be applied directly. The specific projection is dependent on which productions are selected. Essentially, each selected production results in a bifurcation of the transformation graph around the node(s) containing the production, and the optimal route is then calculated across the bifurcated graph. This process can be better understood with reference to the following examples.

### EXAMPLE 1

In this example, a document needs to be transformed from format A to format B and there is a single production type that needs to be applied, which has instances at both format nodes C and D. Accordingly, a modified or “bifurcated” transformation graph 200a may be generated as shown in FIG. 2a. Note how the bifurcated transformation graph 200a is reflected around the nodes containing the production (i.e., formats C and D). The productions are now represented by simple directed edges without any self-loops.

The “prime” nodes (A′-D′) represent the same document formats as the corresponding original nodes, but with the production applied. The problem is thus reduced to finding an optimal path from node A to node B′ on the bifurcated graph, which is more amenable to the Dijkstra algorithm (and others).

It is noted that bifurcation may be applied to any number of nodes, as illustrated by the next example.

### EXAMPLE 2

In this example, two different production types need to be applied, which have instances at nodes C and D respectively. Accordingly, a modified or “bifurcated” transformation graph 200b may be generated as shown in FIG. 2b. In FIG. 2b, the transformation graph 200 has been bifurcated twice, resulting in a bifurcated transformation graph 200b including four “copies” of each node. As with the first example, the productions are transmuted from self-loops to simple directed edges. The problem devolves to finding the optimal path from node A to node B″ (the version of B with both transformations applied). Again, the Dijkstra algorithm can be readily applied directly to the bifurcated graph.

Although the examples so far have been fairly simple, this technique can be extended to transformation graphs and production requests of any complexity. Bifurcation of the transformation graph due to the presence of productions can result in an extensive graph structure. Since, in the general case, every job passing through the delivery pathway may require a different set of productions, calculating optimal paths could become computationally expensive.

However, the topology of the bifurcations is essentially a copy of the original graph. Accordingly, there is no need to generate the entire structure explicitly in memory, and the problem of calculating an optimal route with productions can be simplified considerably, as illustrated in the next example.

### EXAMPLE 3

This example takes advantage of the symmetry in the bifurcated graph to considerably simplify the route calculation process. First, the Dijkstra algorithm is applied to the initial transformation graph 200 (FIG. 2) to calculate optimal routes between every pair of nodes. This information is cached.

Second, a bifurcated transformation graph 200b (FIG. 2b) is created when productions are selected. However, because the optimal routes between points in the initial transformation graph 200 (a.k.a. optimal sub-routes) are already known from application of the Dijkstra algorithm to the initial transformation graph 200, a simplified bifurcated graph 200c can be created, as shown in FIG. 2c.

The simplified transformation graph 200c contains only active format nodes, i.e., the beginning node (e.g., format A), final node (e.g., format B″), and nodes at which requested productions are available. The edges between the nodes in the simplified bifurcated graph 200c have weights that equal the total weight of the pre-calculated optimal sub-routes between the active nodes.

Third, the optimal route through the simplified bifurcated graph 200c is determined. Note that the total number of routes through the simplified graph is less than or equal to nl (n factorial), where n is the total number of productions to be applied. Since this number is, in most cases, relatively small, it may be most efficient to select an optimal route from among these possibilities using a simple linear search. However, other methods for determining an optimal route may also be used, as will be readily understood by those having ordinary skill in the art after becoming familiar with the teachings herein.

Fourth, after the optimal route through the simplified bifurcated graph is determined, optimal sub-routes from the first step may be substituted back in. This gives the complete route including all required transformations and productions.

It is noted that in some cases, the order in which productions are applied to a document may be significant. In these cases, the same algorithm described above can be applied. However, in step 3 some of the possible routes from the simplified bifurcated graph may be disallowed by the production ordering constraints and can thus be thrown out. The optimal path can then be selected from among the remaining routes.

It is also noted that the edges in the graph may be weighted. Appropriate weights for the transformation and production edges in the graph may be computed based on associated data describing their respective computational cost and/or level of fidelity/quality.

It is further noted that the examples described above with reference to FIGS. 2 and 2a-c are merely illustrative and are not intended to be limiting.

### Exemplary Operations

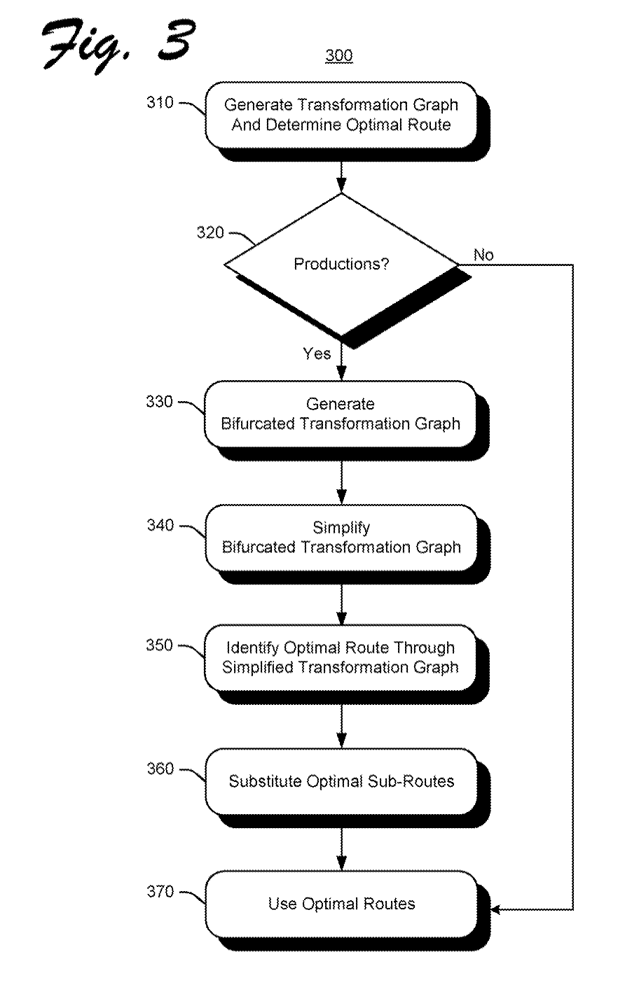

FIG. 3 is a flowchart illustrating exemplary operations which may be implemented for output management. Operations 300 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used for output management.

In operation 310, a transformation graph is generated and the optimal route(s) between every pair of nodes in the transformation graph is determined. In operation 320 a determination is made whether productions are selected. If no productions are selected, operations proceed to operation 370 wherein the optimal route(s) are used from operation 310.

If productions are selected, a bifurcated transformation graph is created in operation 330, and the bifurcated transformation graph is simplified in operation 340. As discussed above, the simplified transformation graph contains only active format nodes and nodes at which requested productions are available. If weighting is used, the edges between the nodes in the simplified bifurcated graph have weights that equal the total weight of the pre-calculated optimal sub-routes between the active nodes.

In operation 350, the optimal route through the simplified bifurcated graph is determined. In operation 360, optimal sub-routes determined in operation 310 may be substituted back in for complete routing including all required transformations and productions. In operation 370 the optimal route(s) are used for productions as determined in operation 360.

The operations shown and described herein are provided to illustrate exemplary implementations of output management. It is noted that the operations are not limited to the ordering shown. Still other operations may also be implemented.

It is noted that the exemplary embodiments shown and described are provided for purposes of illustration and are not intended to be limiting. Still other embodiments are also contemplated.

1. A output management method comprising:
generating a bifurcated transformation graph including a plurality of format nodes connected by a plurality of transformation edges and at least one production edge;
simplifying the bifurcated transformation graph; and
identifying at least one optimal route through the simplified bifurcated transformation graph for efficient document management in a computer system.

2. The method of claim 1, further comprising generating a transformation graph before generating the bifurcated transformation graph.

3. The method of claim 2, further comprising determining at least one optimal sub-route through the transformation graph.

4. The method of claim 3, further comprising substituting the at least one optimal sub-route into the simplified bifurcated transformation graph.

5. The method of claim 1, wherein the simplified bifurcated transformation graph includes nodes at which requested productions are available.

6. The method of claim 1, wherein the simplified bifurcated transformation graph includes active format nodes.

7. The method of claim 6, wherein the transformation edges and production edges have weights that equal a total weight of pre-calculated optimal sub-routes between the active nodes.

8. The method of claim 7, wherein the weights for the transformation edges and production edges are computed based on associated data describing respective computational cost and/or level of fidelity/quality.

9. The method of claim 1, wherein the bifurcated transformation graph is bifurcated around the at least one production edge.

10. An output management system comprising:
a bifurcated transformation graph stored in computer readable storage; and
at least one processing unit accessing the bifurcated transformation graph from the computer readable storage, the at least one processing unit simplifying the bifurcated transformation graph and identifying at least one optimal route through the simplified bifurcated transformation graph, wherein the at least one optimal route is used for efficient document management in a computer system.

11. The system of claim 10, further comprising a transformation graph including a plurality of format nodes connected by a plurality of transformation edges and at least one production edge.

12. The system of claim 11, wherein the transformation graph is used to generate the bifurcated transformation graph.

13. The system of claim 11, wherein the at least one processing unit determines at least one optimal sub-route through the transformation graph.

14. The system of claim 13, wherein the at least one optimal sub-route is substituted into the simplified bifurcated transformation graph.

15. The system of claim 10, wherein the simplified bifurcated transformation graph includes only active format nodes and nodes at which requested productions are available.

16. The system of claim 10, wherein the transformation edges and production edges are weighted.

17. The system of claim 16, wherein the weights for the transformation edges and production edges are computed based on associated data describing respective computational cost and/or level of fidelity/quality.

18. The system of claim 16, wherein the transformation edges and production edges in the simplified bifurcated transformation graph have weights that equal a total weight of pre-calculated optimal sub-routes between the active nodes.

19. A system comprising:
means of bifurcating a transformation graph including a plurality of nodes connected by a plurality of edges and at least one self-loop;
means for simplifying the bifurcated transformation graph; and
means for identifying at least one optimal route through the simplified bifurcated transformation graph.

20. The system of claim 19, further comprising means for weighting the edges and at least one self-loop based on associated data describing respective computational cost and/or level of fidelity/quality.

21. The system of claim 19, wherein the simplified bifurcated transformation graph includes only active nodes.
